(19) United States
(12) Patent Application Publication
(10) Pub. No.: US 2015/0294034 A1
(43) Pub. Date: Oct. 15, 2015

(54) MACHINE TOOL DESIGN METHOD AND MACHINE TOOL DESIGN SYSTEM

(71) Applicant: INDUSTRIAL TECHNOLOGY RESEARCH INSTITUTE, Chutung (TW)

(72) Inventors: Chien-Chih Liao, Chutung (TW); Chin-Te Lin, Chutung (TW); Pei-Yin Chen, Chutung (TW); Tzuo-Liang Luo, Chutung (TW)

(73) Assignee: INDUSTRIAL TECHNOLOGY RESEARCH INSTITUTE, Chutung (TW)

(21) Appl. No.: 14/528,175

(22) Filed: Oct. 30, 2014

(30) Foreign Application Priority Data
Apr. 11, 2014 (TW) 103113362

(51) Int. Cl. G06F 17/50

(52) U.S. Cl. CPC G06F 17/50; G06F 17/5018

(57) ABSTRACT

A machine tool design method includes: receiving a finite element model of tool-spindle system including a cutting tool, a working spindle speed range, and a target cutting depth; providing a simplified finite element model of main frames of machine tool and initializing its configuration parameters including an equivalent stiffness and an equivalent mass; combining the simplified finite element model of main frames of machine tool with the finite element model of tool-spindle system to construct an equivalent machine tool model; according to a response of the configuration parameters, proceeding a cutting stability prediction of the equivalent machine tool model, and computing an objective function value based on a predicted result; and determining whether the objective function value meets a preset design requirement, if yes, employing the configuration parameters to be references to design a machine tool, if not, updating the configuration parameters and proceeding the cutting stability prediction again.

### CROSS-REFERENCE TO RELATED APPLICATION

This application claims foreign priority under 35 U.S.C. §119(a) to Patent Application No. 103113362, filed on Apr. 11, 2014, in the Intellectual Property Office of Ministry of Economic Affairs, Republic of China (Taiwan, R.O.C.), the entire content of which Patent Application is incorporated herein by reference.

### TECHNICAL FIELD

This disclosure relates to a machine tools design technology, and more specifically, relates to a design method and a design system of machine tools.

### BACKGROUND OF THE INVENTION

Currently, the design procedure of modern machine tools usually depends on the experience. To test the cutting ability of a machine, the cutting performance test is conducted after completing manufacturing and assembling the machine. If the stiffness of the machine is insufficient, it will consume a huge amount of time, labor cost and money to modify the design. However, the machine tool design is only worthy of use, and it is unable to predict the final performance of the machine tool but results in wasting time and money. In addition, the current design procedure lacks theoretical background. The imagination of engineers is restricted by their previous experience thus it is difficult to produce breakthrough designs.

Specifically, the current machine tools design technology is more focused on structural performance optimization and rarely noticed manufacturing optimization, which results in the design result may not be able to satisfy the requirements of the manufacturing process. For example, the spindle performance could be optimized by computing technique, such as improving the spindle installation position or interface to optimize the cutting performance through the structure analysis technique and the chatter stability analysis technique. However, the designed machine tool may not be able to fulfill the usage requirement if the effect of machine frame structure on the machine performance is not considered. For example, the generative chatter is an undesired machining phenomenon due to the occurrence of the inverted excitation between the cutting tool and workpiece, which can result in poor surface roughness of the workpiece, shortening the life of cutting tools and even damaging the spindle, and then increasing the machining cost and manufacturing time. The chatter stability analysis is a cutting mechanics analysis technology, which is able to predict the chatter zone on the basis of the frequency response function, FRF (the demonstration of machine dynamics, the material properties of the workpieces and the properties of the cutting tools.) The result of chatter stability analysis is often converted to a stability critical curve of the spindle speed versus the cutting depth as shown in FIGS. 7A and 7B, wherein a stable zone is below the curve and a chatter zone is above the curve. The above is described in advance herein.

Therefore, the engineers who are skilled in the art need a machine tool design technique that can generate optimized machine structures subject to manufacturing process requirement, and also can significantly reduce the risk of designing a new product, improving the reliability and quality of the design product, testing creative ideas without risks, and shortening the completed machine development period. The method of this disclosure can enhance the machine tools from the design which is merely worthy to use for an optimized design. This is a technical issue that the persons who are skilled in the art desperately want to solve.

### SUMMARY OF THE INVENTION

The disclosure provides a machine tool design method, comprising: receiving a finite element model of tool-spindle system including at least a spindle and a cutting tool, and receiving a working spindle speed range and a target cutting depth; providing a simplified finite element model of main frames of machine tool and initializing its configuration parameters, including an equivalent stiffness and an equivalent mass; combining the simplified finite element model of main frames of machine tool with the finite element model of tool-spindle system to construct an equivalent machine tool model; according to a responses of the configuration parameters of the simplified finite element model of main frames of machine tool, predicting a cutting stability of the equivalent machine tool model and computing an objective function value, based on a predicted result; and determining whether the objective function value meets a preset design requirement, if yes, employing the configuration parameters of the main frames of machine tool to be references to design a machine tool, if not, updating the configuration parameters of the main frames of machine tool and predicting the cutting stability again.

In addition, the disclosure further provides a machine tool design system, comprising: an input unit, for inputting a finite element model of tool-spindle system including at least a spindle and a cutting tool, and inputting a working spindle speed range and a target cutting depth; a machine frame shape generation unit for constructing a simplified finite element model of main frames of machine tool and initializing its configuration parameters, including an equivalent stiffness and an equivalent mass; a model combining unit, for combining the simplified finite element of main frames of machine tool with the finite element model of tool-spindle system to construct an equivalent machine tool model; a cutting stability prediction unit, for predicting a cutting stability of the equivalent machine tool model and computing an objective function value, based on a responses of the configuration parameters of the simplified finite element of main frames of machine tool; and a determination unit, for determining whether the objective function value meets a preset design, if yes, employing the configuration parameters of the simplified finite element of main frames of machine tool to be references to design a machine tool, if not, updating the configuration parameters of the simplified finite element of main frames of machine tool and predicting the cutting stability again.

From the above, the machine tool design method and machine tool design system for the disclosure mainly utilize the structure analysis technique, the chatter stability analysis technique, the parameters optimization technique and so on, further incorporate with design database to aid engineers rapidly design a machine tool. Whether having experience of designing machine tools or not, engineers can design a machine tool for a machining process purpose. It reduces the burden of engineers and further helps them escaping from the restriction of prior experience to propose breakthrough designs.

### BRIEF DESCRIPTION OF THE DRAWINGS

FIG. 1 is a flow chart depicting an embodiment of the machine tool design method of the disclosure.

FIG. 2 is a schematic diagram depicting an embodiment of the machine tool design system of the disclosure.

FIG. 3 is a schematic diagram depicting an embodiment of the simplified finite element model of main frames of machine tool.

FIG. 4 depicts a frequency response diagram of a machine tool.

FIG. 5 is a schematic diagram depicting an equivalent machine tool model of the machine tool of the disclosure.

FIG. 6 is an appearance figure of the original design of the machine tool of an embodiment of the disclosure.

FIGS. 7A and 7B are the chatter stability lobe diagrams before and after machine tool optimization of an embodiment of the disclosure, wherein the area below the curve is the stable zone and the area above the curve is the chatter zone.

FIGS. 8A, 8B, and 8C are the design figures after machine tool optimization of an embodiment of the disclosure.

### DETAILED DESCRIPTION OF THE INVENTION

The detail description of the disclosure is described by specific embodiments in the following. Those with ordinary skills in the arts can readily understand the other functions of the disclosure after reading the disclosure of this specification. The disclosure can also be implemented with different embodiments and examples.

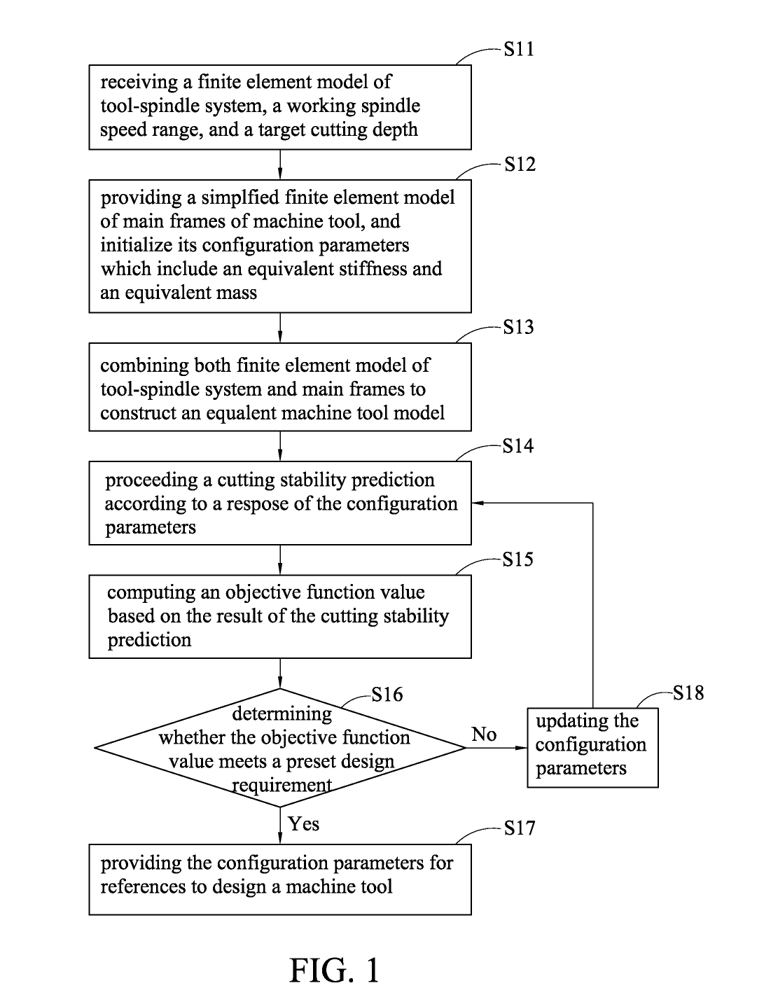

FIG. 1 is a flow chart depicting the machine tool design method of the disclosure. As shown in the figure, machine tools are designed by providing, for example, the structure analysis technique, the chatter stability analysis technique, the parameter optimization and topology optimization, and incorporating design database aid design. The topology optimization is a mathematical method for designing an optimized material allocation in a given space to achieve a specific purpose under given loading and boundary conditions. For example in machine tools design, the given design space is the solid shape of the machine tool frame structure and the topology optimization, under the design constraints such as stiffness, performance or cost, arranges the material distribution inside the shape to obtain the best machine tool structure performance. The above is described in advance herein.

In step S11, the disclosure provides engineers to input a finite element model of tool-spindle system including at least a spindle and a cutting tool, and also input a working spindle speed range and a target cutting depth. In another embodiment, except including the spindle and the cutting tool, the finite element model of tool-spindle system inputted by engineers can further include, but not limited to, a cutting tool holder to ensure the cutting tool aligning to the rotating axis of the spindle. More specifically, when designing a machine tool to meet a process purpose, the specifications of the spindle and the motor can be determined in light of the process purpose. For example, cutting Titanium alloy requires a large torque spindle to produce larger cutting force, and cutting Aluminum alloy requires the spindle having high spindle speed to avoid chips adhering. Therefore, in this step, engineers firstly construct the finite element model of tool-spindle system including at least one spindle and one cutting tool, or and not limited to, the engineers choose the finite element model of tool-spindle system including at least one spindle and one cutting tool from a pre-constructed database. In addition, this step can also input design constraints, such as the mass of the machine tool should be lower than 1500 kg or the stiffness of the machine tool should be higher than 80 N/um, for the following parameter optimization.

After setting the process purpose, for example, engineers can further input a working spindle speed range and a target cutting depth, i.e., through the relationship between the cutting tool geometry and the material properties, those who skilled in the metal cutting machining technology can calculate a proper working spindle speed or a working spindle speed range. In addition, for the users are not familiar with the metal cutting machining technology, they can use the workpieces material database and well-known machining equation to generate the working spindle speed range, after inputting the material properties of the workpieces and the characteristics of the cutting tool.

In step S12, at least one simplified finite element model of main frames of machine tool is provided for selection, and its configuration parameters which include an equivalent stiffness and an equivalent mass are initialized, as shown in FIG. 3. A complete frame shape of the machine tool 31 includes a bed frame 311, a column frame 313, a head frame 315, and other essential components. The complete frame shape of the machine tool can be represented by a simplified finite element model of main frames of machine tool including an equivalent stiffness K and an equivalent mass M. The configuration parameter simplification method will be described later. The initial values of the parameters in the following parameter optimization can be the maximum values, user-defined values, or others which are not limited to in the disclosure of the equivalent stiffness and the equivalent mass.

In step S13, the main frames are combined with the finite element model of tool-spindle system to construct an equivalent machine tool model, as shown in FIG. 5, so as to conducting the following prediction steps, wherein the combining method will be described later. It should be described that after the completed configuration of machine tools are directly combined with the finite element model of tool-spindle system, the chatter stability prediction is carried on through the following steps. During the steps, a huge amount of finite elements will be generated and consume very long time to calculate and optimize the cutting performance. Therefore, step S12 of the disclosure simplifying the configuration design to a simple system of the equivalent stiffness and the equivalent mass will benefit to enhance the efficiency of the machine tool design.

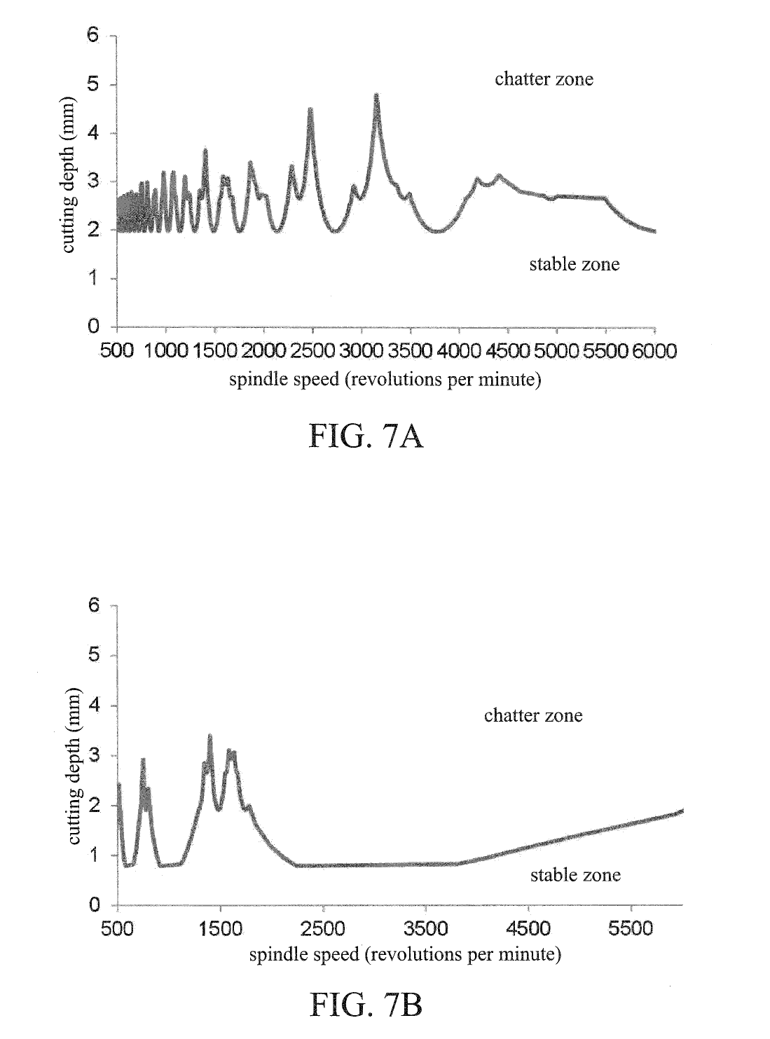

In step S14, according to the two previous mentioned parameters, the equivalent stiffness and the equivalent mass, the cutting stability of the equivalent machine tool model is predicted. After the finite element analysis, the equivalent machine tool model in step S13 will generate the frequency response function (FRF) of the tool center point (TCP), and then compute each critical cutting depth of each working spindle speed in light of Altintas and Budak's chatter analysis theory, so as to generate the cutting stability prediction, i.e., the chatter stability lobe diagram of the chatter theory, as shown in FIGS. 7A and 7B. For convenient, step S14 conducts the cutting stability prediction based on the previous mentioned configuration parameters of the simplified finite element model of main frames of machine tool, so that can obtain a cutting depth satisfying the previous mentioned working spindle speed range.

In step S15, based on the result of the cutting stability prediction in the previous step, i.e., the configuration parameters of the simplified finite element model of main frames of machine tool, an objective function value is then computed. The objective function value, for example, can be a performance value generated by aforementioned parameters. The performance value can be adjusted by subtracting a penalty term, when the responses of configuration parameters violates some design constraints. The specific definition of the objective function value depends upon the selected optimal design method, and it is not limited by the disclosure.

Whether the objective function value by the prediction meets a preset design requirement or not is determined in step S16. An optimal design problem is consisted of the objective function, the configuration parameters of the simplified finite element model of main frames of machine tool and the design constraints. The so-called optimal design is finding a set of design parameters which can generate the best objective function value subject to the given design constraints. In this step, the design constraints are firstly check if being violated. If no, then according to the objective function value, the equivalent stiffness and the equivalent mass, the convergence check is conducted to determine whether the objective function value meets a preset design requirement or not. The specific check method also depends upon the selected optimal design method. If the objective function value meets a preset design requirement, go to step S17, the configuration parameters of the simplified finite element model of main frames of machine tool are provided to be references to design a machine tool. If not, go to step S18, the configuration parameters of the simplified finite element model of main frames of machine tool are updated and back to step S14 and the cutting stability prediction is re-conducted until the objective function value meets a preset design requirement, for example, until the obtained cutting depth conforms aforementioned target cutting depth.

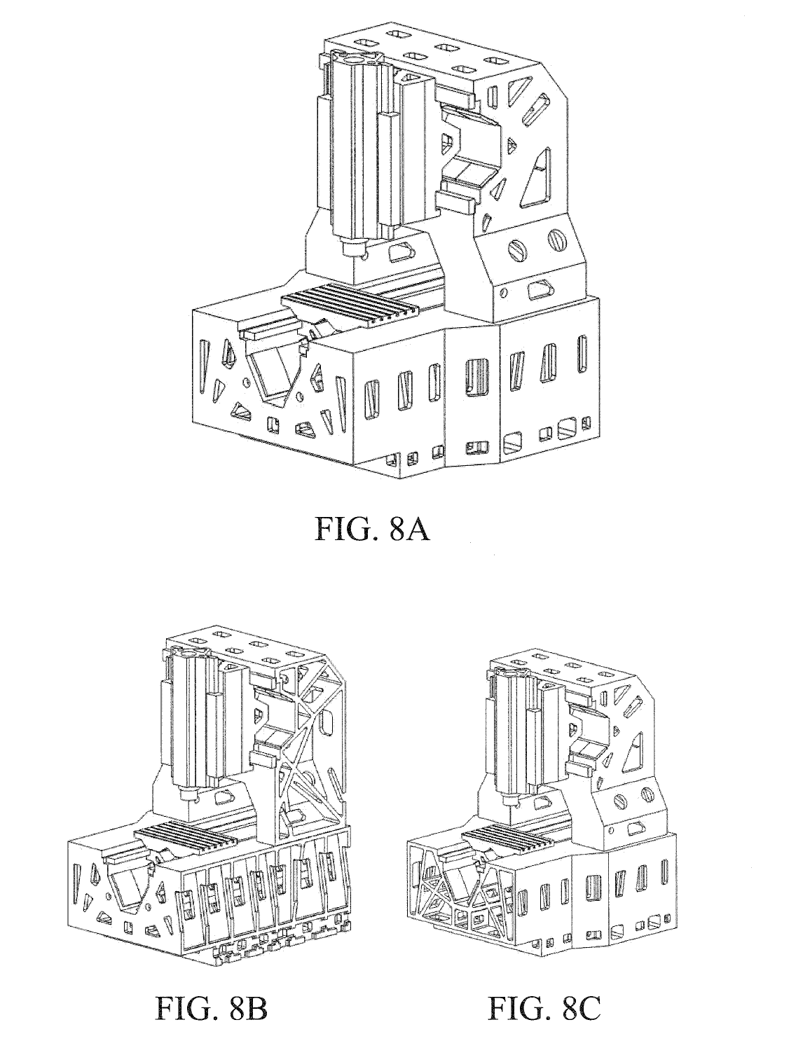

In step S17, for example, further comprising, but not limited to in the disclosure, if the objective function value meets a preset design requirement, i.e., the cutting depth conforms aforementioned target cutting depth, a topology optimization process is further conducted to generate optimal simplified finite element model of main frames of machine tool according to the configuration parameters of the simplified finite element model of main frames of machine tool. The optimal simplified finite element model of main frames of machine tool is then provided to be the basis or references to design a machine tool. In other words, the topology optimization can use the configuration parameters of the simplified finite element model of main frames of machine tool as the objective or constraints and incorporate with the design for manufacturability and the preference of engineers, so as to generate a machine tool shape design figures which satisfies the requirements of manufacturing process for reference or utilization. The so-called basis or references to design a machine tool above are provided to engineers to select or adjust depending upon their requirements. The disclosure of this is not limited or restricted, such as each example shown in FIGS. 8A to 8C.

Through the aforementioned method of the disclosure, the machine tool engineers only need to select a spindle, tools or other equipment required by the manufacturing process, determine the conditions of manufacturing process and select the desired simplified finite element model of main frames of machine tool, and then they will be able to obtain the reliable and effective design parameters for topology optimization.

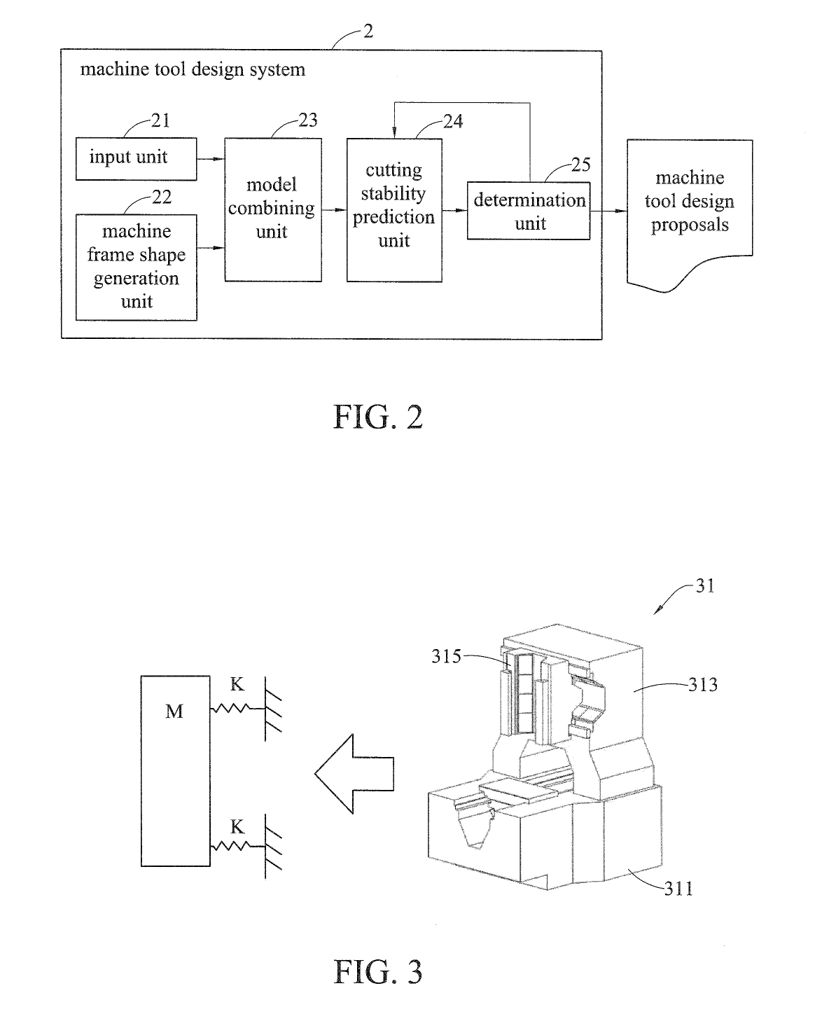

FIG. 2 is a system diagram depicting the machine tool design system of the disclosure. As shown in the figure, the machine tool design system 2 includes, for example, an input unit 21, a machine frame shape generation unit 22, a model combining unit 23, a cutting stability prediction unit 24 and a determination unit 25.

The input unit 21 provides engineers to input or select a finite element model of tool-spindle system including at least a spindle and a cutting tool, and input a working spindle speed range and a target cutting depth, i.e., determining the desired specification of the spindle and the motor in light of the objective of the manufacturing process and define the proper spindle speed or working spindle speed range of the machine tool in light of the cutting tool geometry and material properties, such as those the working spindle speed range is generated based on the workpiece material and the features of the cutting tool. However, the disclosure is not limited to the above. Please also refer to step S11 of FIG. 1.

The machine frame shape generation unit 22 constructs a simplified finite element model of main frames of machine tool and initializes configuration parameters of simplified finite element model of main frames of machine tool which include an equivalent stiffness K and an equivalent mass M, as shown in step S12 of FIG. 1 and FIG. 3. That is selecting the desired machine appearance shape to generate the simplified finite element model of main frames of machine tool. The machine tool design system 2 can construct various simplified models in advance for engineers to select. In addition, engineers can import their models into the machine tool design system 2. For example, the models can be converted to files with data exchange format, like STEP or STL, and then the machine tool design system 2 imports the files. Moreover, in order to simplify the computation of the machine tool configuration, the system of the configuration parameters of the simplified finite element model of main frames of machine tool including the equivalent stiffness and the equivalent mass is selected to conduct analysis computation, so as to improve the design efficiency of the machine tool.

In specific implementation, the maximum values of the configuration parameters of machine tool model are the equivalent values of a solid frame shape of machine tool of the simplified finite element model of main frames of machine tool, that is the upper limit of the parameters because a solid structure has maximum mass and stiffness compared to a hollow structure. Therefore, the initial configuration parameters of the simplified finite element model of main frames of machine tool can be the values between the maximum values and zero. In the consideration of readily analysis, the maximum values can be selected as the initial values, and then decreases as the prediction result successively, as shown in step S18 in FIG. 1.

The model combining unit 23 combines or integrates the main frames with the finite element model of tool-spindle system to construct an equivalent machine tool model, as shown in step S13 in FIG. 1. Briefly speaking, that is combining the finite element model of tool-spindle system constructed or inputted by the input unit 21 with the main frames generated or built-in by the machine frame model generation unit 22 to generate an initial equivalent machine tool model for prediction. The so-called combination is achieved by adding an interfacial stiffness Ki between the finite element models of the main frames and tool-spindle system.

The cutting stability prediction unit 24 predicts the cutting stability of the equivalent machine tool model to obtain a cutting depth which conforms the working spindle speed range, as shown in step S14 of FIG. 1. The cutting stability prediction unit 24 conducts the cutting ability prediction for the equivalent machine tool model generated by the model combining unit 23 and represent the predicted result as a stability curve calculated based on the frequency response function (FRF) of the equivalent machine tool model, so as to obtain the cutting depth within the working spindle speed range.

The determination unit 25 is used to determine whether the objective function value meets a preset design requirement or not, as shown in step S16 of FIG. 1. If yes, the configuration parameters of simplified finite element model of main frames of machine tool are provided as the basis or references to design a machine tool. Otherwise, the configuration parameters and the equivalent machine tool model are updated to re-conduct the cutting stability prediction until the objective function value meets a preset design requirement, i.e., the configuration parameters of the simplified finite element model of main frames of machine tool have the best performance under the design constraints.

In addition, the determination unit 25, for example, can further comprise executing a topology optimization program according to the configuration parameters of simplified finite element model of main frames of machine tool to generate an optimal simplified finite element model of main frames of machine tool, when the objective function value meets a preset design requirement. Then, the optimal simplified finite element model of main frames of machine tool is used as the basis or references to design a machine tool. However, the disclosure is not limited thereto. In other words, the shapes of simplified finite element model of main frames of machine tool are optimized by the topology optimization program to be the references to design a machine tool and then incorporated with the design for manufacturability and the preference of engineers, so that the machine tool configuration design figures which satisfy the requirements are generated.

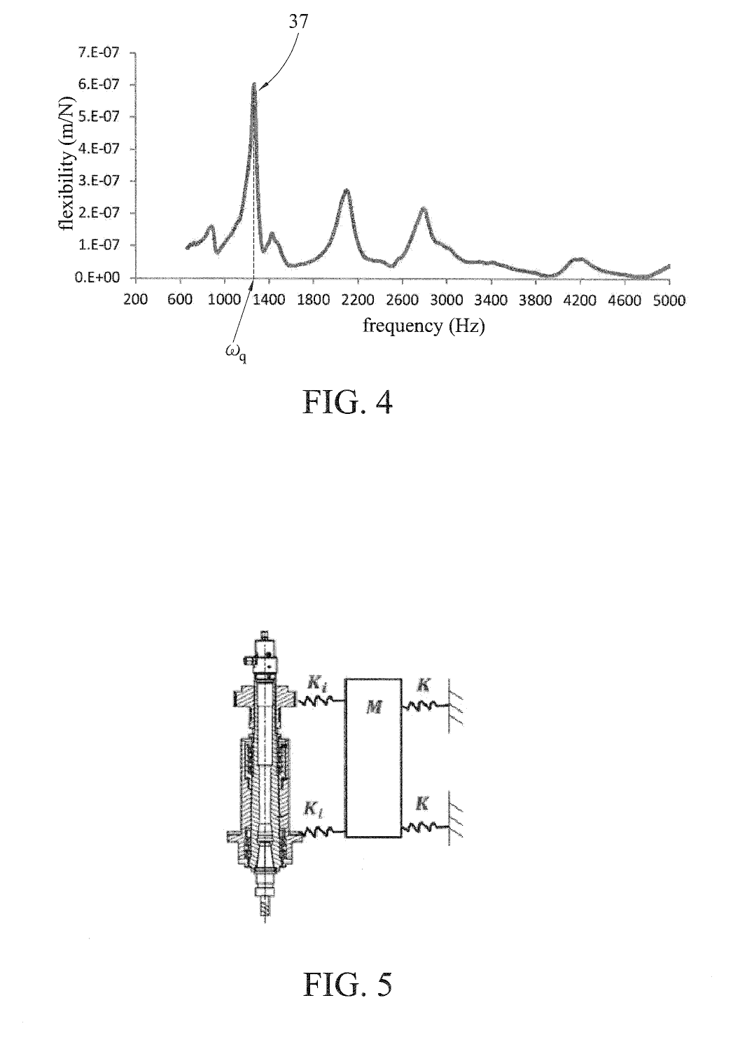

The aforementioned configuration parameter simplification method, as shown in step S12 of FIG. 1, can refer to FIG. 3. That is the calculation method of the equivalent mass M and the equivalent stiffness K of the simplified finite element model of main frames of machine tool at the tool center point (TCP). It will be described in detail below. First of all, when designing a machine tool which conforms its requirements, the appearance configuration 31 is determined or selected first. Next, the FRF and the vibration mode of TCP are obtained through the finite element harmonic analysis. FIG. 4 shows the FRF diagram of the appearance configuration 31, wherein the horizontal axis is frequency and the vertical axis is the flexibility. The so-called flexibility is the reciprocal of the stiffness for representing the deformation of the machine tool by the unit force. Therefore, the maximum flexibility in the figure is the vibration mode 37 marked in the figure and the corresponding frequency is about the modal frequency ω_{q} of the vibration mode.

The equivalent stiffness K and the equivalent mass M can be calculated by the modal frequency ω_{q} of the vibration mode and the kinetic energy in the mode shape. After knowing the modal frequency ω_{q}, it can be obtained through the finite element modal analysis to analyze the corresponding mode. M and K of TCP can be represented by the masses mᵢ, stiffnesses kᵢ and the vibration values xᵢ of each component under the vibration mode. Therefore, the value of M can be calculated by the kinetic energy conservation in the following equation:

$$\frac{1}{2} {Mx}_{TCP}^{2} {ω}_{q}^{2} = \sum \frac{1}{2} {m}_{i} {x}_{i}^{2} {ω}_{q}^{2}$$

Eliminating the modal frequency and arranging the above equation can obtain:

$$M = \frac{2}{{x}_{TCP}^{2}} \sum \frac{1}{2} {m}_{i} {x}_{i}^{2}$$

The value of K can be calculated based on the modal frequency and the equivalent stiffness:

$${ω}_{q} = \sqrt{K \text{/} M}$$

Therefore, the simplified finite element model of main frames of machine tool in FIG. 3 can be obtained. Using the FRF of FIG. 4 as an example, M equals to around 0.6421 kg and K equals to around 4.0689E+7 N/m can be obtained. It should be mentioned that the values of M and K are defined by the modal shape. If a vibration mode only has a specific local vibrating part, the values of M and K will be much smaller than the whole structure.

Please refer to FIG. 5 for the combining method of combining the aforementioned main frames and the finite element model of tool-spindle system to an equivalent machine tool model. Their combination or integration is completed by adding an interfacial stiffness Ki between them. Generally, when a spindle installs into the head frame of a machine tool, an interfacial stiffness exists between the spindle and the head frame and its value is usually fixed or empirical. As shown in the figure, the generation method of the equivalent model proposed in the disclosure is described.

In addition, there is an interfacial stiffness between the structure of machine tool and the spindle stiffness. The interfacial stiffness is usually treated as a fixed value in a standard assembly condition. The interfacial stiffness and the stiffness and mass of the machine tool have important effect on machine tool design. For example, the static stiffness of the machine tool means the ability of the machine tool to against deformation under a static loading, so it is not required to design an over strong structure as long as the structure satisfying the static stiffness, i.e., while the machine tool operating, the deformation of the maximum force is within the permissible range. Moreover, for the dynamic characteristics, the modal frequency can be changed by adjusting the ratio of the equivalent stiffness and the equivalent mass, so as to avoid occurring resonance during the manufacturing process and to ensure the dynamic stiffness is within the permissible range. Therefore, the equivalent stiffness and the equivalent mass need to be set in step S13 for the machine tool design.

It is necessary to applying the optimization method in the aforementioned defining the objective function value in step S15 and the method of checking whether the objective function value meets a preset design requirement in step S16. For example, one can refer to Jasbir Arora's book, Introduction of Optimum Design, but the disclosure is not limited thereto. However, if one wants to apply the optimization method, the aforementioned chatter stability prediction result (i.e., the chatter stability lobe diagrams) should be quantified. In order to quantifying the chatter stability prediction result to an objective function value, the working spindle speed range or spindle speed range and the target cutting depth inputted in step S11 are necessary. It can be calculated by a given function. The disclosure proposed a simple function as the following:

$$Objective function value = \sum \frac{1}{1 + \vert \frac{working spindle speed - Target spindle speed}{Target spindle speed} \vert} \times \{ \begin{matrix}cutting depth \text{/} target cutting depth & cutting depth < target cutting depth \\ 1 + \frac{1}{cutting depth \text{/} target cutting depth} & cutting depth \geq target cutting depth\end{matrix}$$

According the simple function, if the obtained chatter stability prediction result conforms the target cutting depth of the objective working spindle speed, a larger objective function value will be obtained. Also, if the available working spindle speed range is wider or the larger cutting depth is available, a larger objective function value will be obtained by this simple function.

The disclosure describes an embodiment of actual quantification. The following table is a chatter stability prediction result. The working spindle speed range is from 1280 to 1320 RPM, which has an average value equal to 1300 RPM. The target cutting depth is 1.8 mm. The components of objective function value under each of the working spindle speed can be calculated by the above equation, and then the objective function value 3.7089 of the chatter stability prediction result without constraints can be obtained by summing all components within the working spindle speed range. During the aforementioned step S14 to S18, every set of parameters will generate a corresponding chatter stability prediction result which can be quantified to an objective function value, so that the numerical method can be employed to conduct parameter searching and to check whether the objective function value meets a preset design requirement or not.

| Working spindle | Cutting | Component of the |
|---|---|---|
| speed | depth | objective function value |
| 1280 | 2.0359 | 0.1072 |
| 1285 | 2.006 | 0.1433 |
| 1290 | 1.9822 | 0.2202 |
| 1295 | 1.9827 | 0.4957 |
| 1300 | 1.9891 | 1.9891 |
| 1305 | 2.0056 | 0.3343 |
| 1310 | 2.0466 | 0.1861 |
| 1315 | 2.0892 | 0.1306 |
| 1320 | 2.1528 | 0.1025 |

| | |
|---|---|
| Sum of the components | 3.7089 |

The disclosure further proposed an embodiment which considered design constraints. If only considers the objective function value but not consider design constraints, the aforementioned method may obtain an over-design resulting in the mass and stiffness of the structure are extremely large.

If the design constraints are considered, several methods are provided by the conventional optimal design methods. The penalty function method is usually carried out as an example. The objective function value considering the design constraints is defined as the sum of the objective function value and the penalty value. The definition is:

the objective function value considering the design constraints=the objective function value without the design constraints−the penalty value,

where the penalty value depends upon whether the design constraints are violated or not. The design constraint can be presented as a parameter value and a constraint value. For example, if a design constraint is the equivalent mass equals to or less than 15 kg, the equivalent mass and 15 kg are the parameter value and the constraint value, respectively. When the parameter value exceeds the constraint value, the design constraints are determined to be violated and the penalty value is increased. The increased value is defined as the square of ((the parameter value−the constraint value)/the constraint value). If no violation, the penalty value will not be increased. For example, the aforementioned design constraint is the equivalent mass equals to or less than 15 kg. If the equivalent mass is 18 kg, the penalty value needs to increase 0.04. After summing with the objective function value without the design constraints 3.7089, the objective function value considering the design constraints is obtained as 3.6689. If there are other design constraints being violated, the objective function value will be sequentially subtracted due to the generated penalty value.

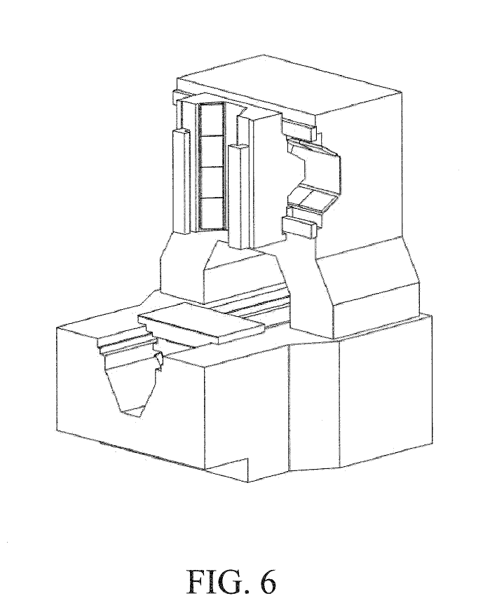

An embodiment of the disclosure is shown in FIG. 6. The designed working spindle speed range of the machine tool is from 1280 to 1320 RPM. The average is 1300 RPM and regarded as a target spindle speed. The target cutting depth is 1.8 mm. The equivalent mass is less than 6000 kg. The initial machine tool configuration is shown in FIG. 6. After calculation, the equivalent stiffness K of the machine tool is 400 N/um and the equivalent mass M is 22,000 kg, so the initial configuration parameters of the simplified finite element model of main frames of machine tool of the equivalent stiffness and the equivalent mass are set as M=22000 and K=400. After combined with the finite element model of tool-spindle system, the predicted chatter stability result is shown in FIG. 7A. The result shows that the 1.8 mm target cutting depth is satisfied in the 1280 to 1320 RPM working spindle speed range of the machine tool, but the equivalent mass is larger than 6000 kg.

After the optimization, the predicted chatter stability result is shown in FIG. 7B. The optimal parameters are the equivalent stiffness of 80 N/um and the equivalent mass of 6000 kg. The 1.8 mm target cutting depth is satisfied in the 1280 to 1320 RPM working spindle speed range of the machine tool. Further using the optimal parameters, the equivalent stiffness of 80 N/um and the equivalent mass of 6000 kg, to conduct the topology optimization, the machine tool configuration design can be obtained as shown in FIG. 8A-8C, which can be the basis or references to design a machine tool. No matter the designer has experience or not, this can improve design efficiency significantly. It is evidenced that the disclosure can break through the restriction of design experience.

Summary from the above, in the machine tool design method of the disclosure, the effect of high efficiently generating the pre-processed parameters of the topology optimization is achieved by the technical manners of the manufacturing process analysis, structure analysis and parameter optimization. Also, the disclosure further proposes to utilize the spindle analysis technique, the chatter stability analysis technique, the topology optimization technique and to incorporate design database to aid engineers designing the machine tools rapidly. For those who do not have experience of machine tool design, they can design the machine tool by focusing on machining process. It is helpful to reduce the burden of engineers during machine design processes. For those who have experience, it also helps to escape the thinking limitation, so as to generate a breakthrough design.

The above embodiments are merely used to describe the effect of the disclosure, but not to limit the disclosure. Those with ordinary skills in the arts can modify or change the above embodiments without departing from the spirit and scope of the disclosure. In addition, the number of components in the above embodiments is for illustration only, also does not used to limit the disclosure.

The disclosure is described by the following specific embodiments and examples. Those with ordinary skills in the arts can readily understand the other functions of the disclosure after reading the disclosure of this specification. The disclosure can also be implemented with different embodiments and examples. Various details described in this specification can be modified based on different viewpoints and applications without departing from the scope of the disclosure. Accordingly, the scope of the disclosure should follow the appended claims.

What is claimed:

1. A machine tool design method, comprising:
receiving a finite element model of tool-spindle system, including a cutting tool, and receiving a working spindle speed range and a target cutting depth;
providing at least a simplified finite element model of main frames of machine tool and setting its initial configuration parameters including an equivalent stiffness and an equivalent mass;
combining the simplified finite element model of main frames of machine tool with the finite element model of tool-spindle system to construct an equivalent machine tool model;
according to a response of the configuration parameters of the simplified finite element model of main frames of machine tool, proceeding a cutting stability prediction of the equivalent machine tool model, and computing an objective function value based on a predicted result, and determining whether the objective function value meets a preset design requirement, if yes, employing the configuration parameters of the simplified finite element model of main frames of machine tool to be references to design a machine tool, if not, updating the configuration parameters of the simplified finite element model of main frames of machine tool and proceeding the cutting stability prediction again.

2. The machine tool design method according to claim 1, wherein combining the simplified finite element model of main frames of machine tool with the finite element model of tool-spindle system refers to further adding an interfacial stiffness thereinbetween.

3. The machine tool design method according to claim 1, wherein proceeding a cutting stability prediction of the equivalent machine tool model determines whether each cutting depth of the working spindle speed range is located in a stable zone, according to a cutting stability curve calculated from a frequency response function of the equivalent machine tool model.

4. The machine tool design method according to claim 3, wherein the predicting result is each of the cutting depth of the working spindle speed range located in the stable zone.

5. The machine tool design method according to claim 1, wherein the objective function value is obtained according to the predicting result, the target cutting depth and an objective spindle speed via a function.

6. The machine tool design method according to claim 1, further comprising, after obtaining the objective function value, determining whether it violates at least one design constraint, if yes, subtracting by a corresponding penalty value.

7. The machine tool design method according to claim 1, wherein upper limits of the configuration parameters are the parameters of a solid frame shape of the simplified finite element model of main frames of machine tool.

8. The machine tool design method according to claim 1, further comprising executing a topology optimization program according to the configuration parameters of the simplified finite element model of main frames of machine tool, if the objective function value meets the preset design requirement.

9. A machine tool design system, comprising:
an input unit configured to receive a finite element model of tool-spindle system including a cutting tool, and to receive a working spindle speed range and a target cutting depth;
a machine frame shape generation unit configured to provide at least a simplified finite element model of main frames of machine tool and to initialize configuration parameters of the simplified finite element model of main frames of machine tool, including an equivalent stiffness and an equivalent mass;
a model combining unit configured to combine the simplified finite element model of main frames of machine tool with the finite element model of tool-spindle system to construct an equivalent machine tool model;
a cutting stability prediction unit, according to a response of the configuration parameters of the simplified finite element model of main frames of machine tool, configured to proceed a cutting stability prediction of the equivalent machine tool model and to compute an objective function value, based on a predicted result; and
a determination unit, configured to determine whether the objective function value meets a preset design requirement, if yes, employing the configuration parameters of the simplified finite element model of main frames of machine tool to be references to design a machine tool, if not, updating the configuration parameters of the simplified finite element model of main frames of machine tool and proceeding a cutting stability prediction again.

10. The machine tool design system according to claim 9, wherein the combination of the simplified finite element model of main frames of machine tool and the finite element model of tool-spindle system refers to adding an interfacial stiffness thereinbetween.

11. The machine tool design system according to claim 9, wherein the cutting stability prediction determines whether each cutting depth of the working spindle speed range is located in a stable zone, according to a cutting stability of frequency response function of the equivalent machine tool model.

12. The machine tool design system according to claim 11, wherein the predicting result is each of the cutting depth of the working spindle speed range located in the stable zone.

13. The machine tool design system according to claim 9, wherein the objective function value is obtained according to the predicting result, the target cutting depth and an objective spindle speed via a function.

14. The machine tool design system according to claim 9, wherein the determination unit, after determining the objective function value, further determines whether it violates at least one design constraint, if yes, subtract it by a corresponding penalty value.

15. The machine tool design system according to claim 9, wherein the upper limit of the configuration parameters is the parameters of a solid frame shape of the simplified finite element model of main frames of machine tool.

16. The machine tool design system according to claim 9, wherein the determination unit further executes a topology optimization program according to the configuration parameters of the simplified finite element model of main frames of machine tool, if the objective function value meets a preset design requirement.
